(19) United States
(12) Patent Application Publication
(10) Pub. No.: US 2009/0282043 A1
(43) Pub. Date: Nov. 12, 2009

(54) System And Method For Concurrency Control Of Logically Grouped Shared Objects In A Multi-User Environment

(76) Inventors: Srinivas Ganesh Dharmavaram, Bangalore (IN); Prasanna Anantharamaiah, Bangalore (IN); Anand Mathew, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/198,896

(22) Filed: Aug. 27, 2008

(30) Foreign Application Priority Data
May 7, 2008 (IN) 1120 / CHE / 2008

(51) Int. Cl. G06F 17/30

(52) U.S. Cl. 707/8; 707/E17.007

(57) ABSTRACT

A system and method for controlling access to an object, logically grouped shared objects or an object associated with one or more logical groups in a multi-user environment having different user privileges is disclosed. In one embodiment, a method for locking based on user and user privileges includes receiving a request from a user for access to one of an object or logically grouped shared objects or an object associated with one or more logical groups, determining whether the request from the user is for the object, if so, determining whether the object is locked by another user, if so, breaking the lock associated with the user holding the lock on the object and allowing access to acquire a write lock associated with the user and granting access to the object, and ending the request session.

### BACKGROUND

A significant feature of current applications in a multi-user environment is the need to support shared/reusable objects. Objects are reusable software entities that can be combined in different combinations or ascribed different attributes for different users. Additionally, objects may require logical grouping based on applications requirements. Because such objects are accessible by multiple processes/users/operations, conflicts may occur if they are not properly coordinated. For example, two processes can attempt to update the same object at the same time.

In such a multiuser environment, a method of controlling access to objects is required such that, updates performed by one user are not overwritten by simultaneous updates by another user. Typically, multiple read accesses are allowed but only single-user update is permitted. One approach for resolving such conflicts is to lock objects when a process is accessing data within an object, and release the lock when the process finishes the access. It is a requirement to take account of a lock state of the objects when requesting access.

Locking records or objects in a database for concurrency is probably the most dissected topic over decades. Relational database systems provide off the shelf support for locking of records for exclusive, update or read access only. However, shared application objects, which could possibly have logically grouped shared objects like a containment hierarchy, bring in special requirements for concurrency control that require proprietary implementations on top of locking interfaces supported by off-the-shelf databases. The problem may become even more complex if the shared application object has different requirements for the sharing of container and contained objects.

### BRIEF DESCRIPTION OF THE DRAWINGS

Example embodiments are illustrated by way of example and not limitation in the figures of the accompanying drawings, in which like references indicate similar elements and in which:

FIG. 1 is a block diagram illustrating locking of a container and contained objects in a multi-user environment, according to one embodiment.

FIG. 2 is process flow of providing a write lock and associated read locks for logically grouped shared objects created during run-time, according to one embodiment.

FIG. 3 is a process flow of locking an object based on user privileges, according to one embodiment.

FIG. 4 is a process flow of hard or unbreakable locking for an object, logically grouped shared objects or an object associated with one or more logical groups, according to one embodiment.

FIG. 5 is a process flow of lock aging or lock timeout for an object, according to one embodiment.

FIG. 6 is a diagrammatic system view of a data processing system in which any of the embodiments disclosed herein may be performed, according to one embodiment.

Other features of the present embodiments will be apparent from the accompanying drawings and from the detailed description that follows.

### DETAILED DESCRIPTION

A system and method for concurrency control of logically grouped shared objects in a multi-user environment is disclosed. In the following description, for purposes of explanation, numerous specific details are set forth in order to provide a thorough understanding of the various embodiments. It will be evident, however, to one skilled in the art that the various embodiments may be practiced without these specific details.

The term “logically grouped shared objects” refers to objects in a containment relationship, association relationship and the like. The terms “logically grouped shared objects” and “related objects” are used interchangeably throughout the document. Further, the terms “container” and “container object” are used interchangeably throughout the document. Also in this document, the term “object” refers to a container or a contained object or a standalone object. One skilled in the art can understand that the terms “container object” and “contained object” are used in the context of logically grouped shared objects.

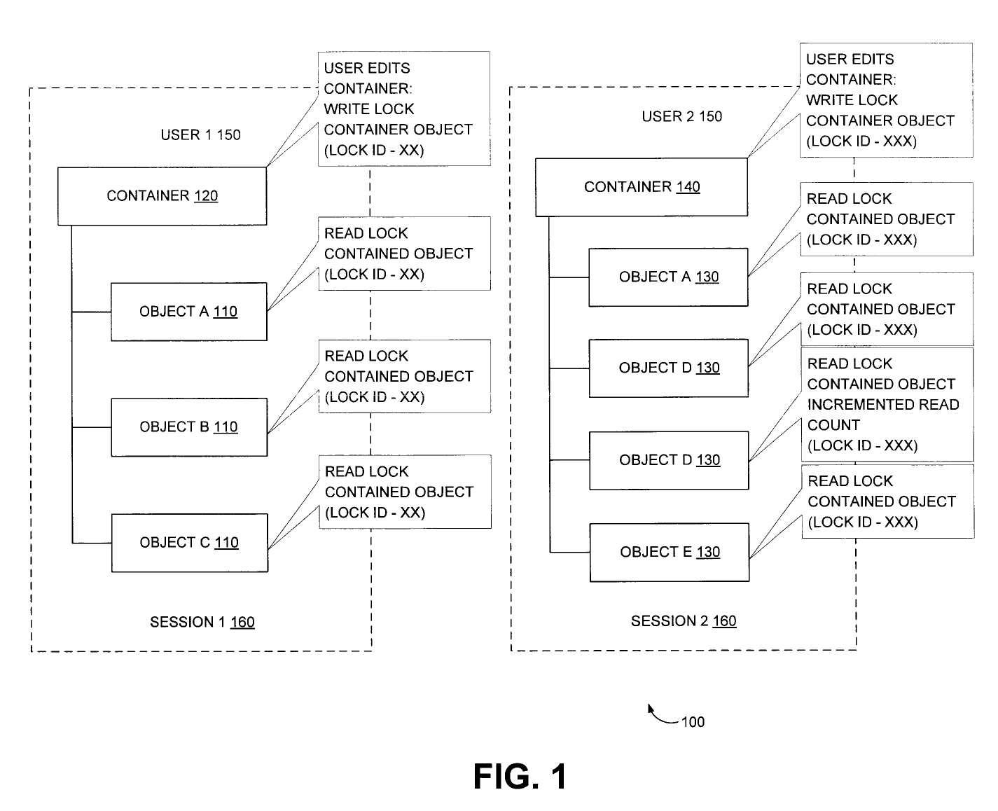

FIG. 1 is a block diagram 100 illustrating locking of a container (e.g., the containers 120 and 140) and contained objects (e.g., the contained objects 110 and 130) in a multi-user environment, according to one embodiment. Particularly FIG. 1 illustrates a first logical grouping of the contained objects 110 in the first container object 120 and a second logical grouping of the contained objects 130 in the second container object 140. Further FIG. 1 illustrates using a single lock id for each of the containers 120 and 140.

In one embodiment, as shown in FIG. 1, the first container object 120 is associated with a user 1 150 and the second container object 140 is associated with a user 2 150. Furthermore, the user 1 150 and the user 2 150 may have different privileges. Thus, the container objects 120 and 140 constitute the multi-user environment having different user privileges. As shown in FIG. 1, the user 1 150 and the user 2 150 are associated with a session 1 160 and a session 2 160 respectively. Further, each of the container objects 120 and 140 and the associated contained objects 110 and 130 forms logically grouped shared objects. In one embodiment, the logically grouped shared objects are formed statically or dynamically using each of the container objects 120 and 140, and its associated contained objects 110 and 130. It can be seen from FIG. 1 that the session 1 160 and session 2 160 are associated with a first set of logically grouped shared objects and a second set of logically grouped shared objects respectively.

In some embodiments, a lock is applied (e.g., based on a request from a user) to each of the logically grouped shared objects in the multi-user environment. In these embodiments, the user (e.g., the user 1 150) acquires a write lock on the container object 120, and a subsequent read locks on the associated contained objects 110. One skilled in the art will understand that the user 1 150 can acquire a lock on the container object 120 or the contained object 110 if the container object 120 or contained object 110 is not write locked by another user. Further, it is to be appreciated that the user 1 150 acquires a write lock when the container object 120 is to be edited. In other words, when the user 1 150 initiates a transaction on the container object 120, the container object 120 is locked for update. One skilled in the art will appreciate that another user (e.g., the user 2 150) can break the write lock on the container object 120 if the user privilege of the user is high.

It is appreciated that read locking the contained object 110 allows the user 1 150 to use the contained object 110 for read-only purpose and prevents the user 1 150 to update the contained object 110. It is also appreciated that multiple users can acquire read lock on the contained object 110. Further, it can be noted the user 1 150 fails to acquire the read lock on the contained object 1 10 if there is a write lock or a hard lock on the logically grouped shared objects. In one embodiment, a hard lock is applied to the container object 120 and/or the contained object 110 which are in a locked state. The hard lock is an internal lock applied (e.g., by the system) when the container object 120 and/or the contained objects 110 are being reconciled on backend applications.

In one example implementation, each lock acquired by the user 1 150 on an object, logically grouped shared objects, an object associated with one or more logical groups is deleted (or released) dynamically, when duration of time for each lock (e.g., created and stored in a lock-master table) exceeds a predetermined threshold value.

For example, consider a locking scenario in a construction of a routing for a call. A routing rule is constructed from building blocks like a decision node and a termination node. The decision node defines possible paths based on certain conditions. The termination node indicates a call termination point (e.g., a landline number). A decision node path can terminate on another decision node or a termination node. Complex routing rules can be constructed by combining different decision nodes and termination nodes. It can be noted that the decision nodes and the termination nodes can be shared across different routing rules.

As shown in FIG. 1, the multi-user environment includes the user 1 150 and the user 2 150 associated with the container object 120 and the container object 140, respectively. Suppose, if the user 1 150 is interested in modifying a routing rule (e.g., the container object 120) which includes decision node (e.g., the contained object A 110) as well as two termination nodes (e.g., the contained object B 110 and the contained object C 110). The locking is applied as shown in FIG. 1. The routing rule (i.e., the container object 120) is write locked by the user 1 150, thereby preventing other users (e.g., the user 2 150) from modifying the routing rule at the same time. It can be noted that any higher privileged user can break the lock and re-acquire a new lock on the same container object 120 if required. The decision node (i.e., the contained object A 110) and the termination nodes (i.e., the contained object B 110 and the contained object C 110) are read locked since they are not being directly worked by the user 1 150. These read locked nodes, i.e., the contained object A 110, the contained object B 110 and the contained object C 110, can be freely used in other routing rules by other users at the same time. However, other users cannot directly work upon the contained object A 110, the contained object B 110, and the contained object C 110 in the read locked state unless, the lock is broken based on a higher user privilege of the user.

Consider another locking scenario (e.g., the session 2 160 shown in FIG. 1) where the user 2 150 is interested in modifying a routing rule (e.g., the container object 140) which includes a decision node (e.g., the contained object A 130) as well as three termination nodes (e.g., the contained object D 130, the contained object D 130, the contained object E 130). The locking is applied as shown in FIG. 1. It can be noted that the decision node (i.e., the contained object A 130) is shared across the user 1 150 and the user 2 150. Further, the termination nodes (i.e., the contained object D 130) are reused by the user 2 150 in the same routing rule.

In some embodiments, lock attributes for the above described locking scenarios associated with each of the container objects 120 and 140 and the contained objects 1 10 and 130 are stored in a lock-master table such as an example table 1 shown below.

TABLE 1

| LOCK | OBJECT | | OBJECT | LOCK | | USER | LOCK | SESSION |
|---|---|---|---|---|---|---|---|---|
| ID | ID | OBJECT TYPE | NAME | TYPE | LOCK TIME | NAME | COUNT | ID |
| 10 | 10 | ROUTING | CONTAINER 1 | WRITE | 4/11/2008 | USER 1 | 1 | 1 |
| | | RULE | | | 6:10:56 AM | | | |
| 10 | 20 | DECISION | OBJ. A | READ | 4/11/2008 | USER 1 | 1 | 1 |
| | | | | | 6:10:56 AM | | | |
| 10 | 15 | TERMINATION | OBJ. B | READ | 4/11/2008 | USER 1 | 1 | 1 |
| | | | | | 6:10:56 AM | | | |
| 10 | 18 | TERMINATION | OBJ. C | READ | 4/11/2008 | USER 1 | 1 | 1 |
| | | | | | 6:10:56 AM | | | |
| 11 | 11 | ROUTING | CONTAINER 2 | WRITE | 4/11/2008 | USER 2 | 1 | 2 |
| | | RULE | | | 6:12:56 AM | | | |
| 11 | 20 | DECISION | OBJ. A | READ | 4/11/2008 | USER 2 | 1 | 2 |
| | | | | | 6:12:56 AM | | | |
| 11 | 30 | TERMINATION | OBJ. D | READ | 4/11/2008 | USER 2 | 2 | 2 |
| | | | | | 6:12:56 AM | | | |
| 11 | 31 | TERMINATION | OBJ. E | READ | 4/11/2008 | USER 2 | 1 | 2 |
| | | | | | 6:12:56 AM | | | |

The example lock-master table 1 illustrated above includes information associated with each lock. As shown in the example table 1, the lock-master table includes the lock attributes such as lock ID, lock type, lock time, object ID, object type, object time, user ID, lock count, session ID, etc. The lock ID is a unique sequence number for each lock. A single lock ID used for a logical group of objects, i.e., the container object 120 and the associated contained objects 110 are assigned a same lock ID (e.g., LOCK ID-XX is assigned for the container object 120 and the associated contained objects 110 as shown in FIG. 1 and the example table 1). The object ID is an ID of the contained object 110 to be locked. The object type is a type of an object (e.g., an object class). The object name shows name of the object. The lock type depicts a lock type such as a read lock, a write lock and a hard lock. The lock time denotes a point in time when a user acquired the lock on the object.

The user name denotes a unique identification or name of the user who acquired the lock on the container object 120 or the contained object 110. The lock count is a count which signifies number of times the contained object 110 is used in a container 120. The session ID is a unique session identifier, assigned for a particular locking session. For example, the user ID and the session ID together identifies the client instance.

In one embodiment, all logically related objects (i.e., the logically grouped shared objects) are grouped under a single lock id in the lock-master table. For example, the single lock ID for the entire logical grouping of objects allows for easier breaking of locks. In other words, the application does not have to keep track of the individual objects associated with the logical group, i.e., only the container object lock Id will suffice. For example, “LOCK ID-XX or XXX” as shown in FIG. 1. Thus, the lock-master table provides a more flexible object lock mechanism for any logical grouping of objects. It is appreciated that the storing of locking information associated with each lock in the lock-master table shown above, facilitates computation of duration of time for each lock for automatic deletion/cleanup of stale lock (e.g., due to some application malfunctioning). In one embodiment, the lock-master table is locked only for release lock and break lock operations to improve the overall performance of locking.

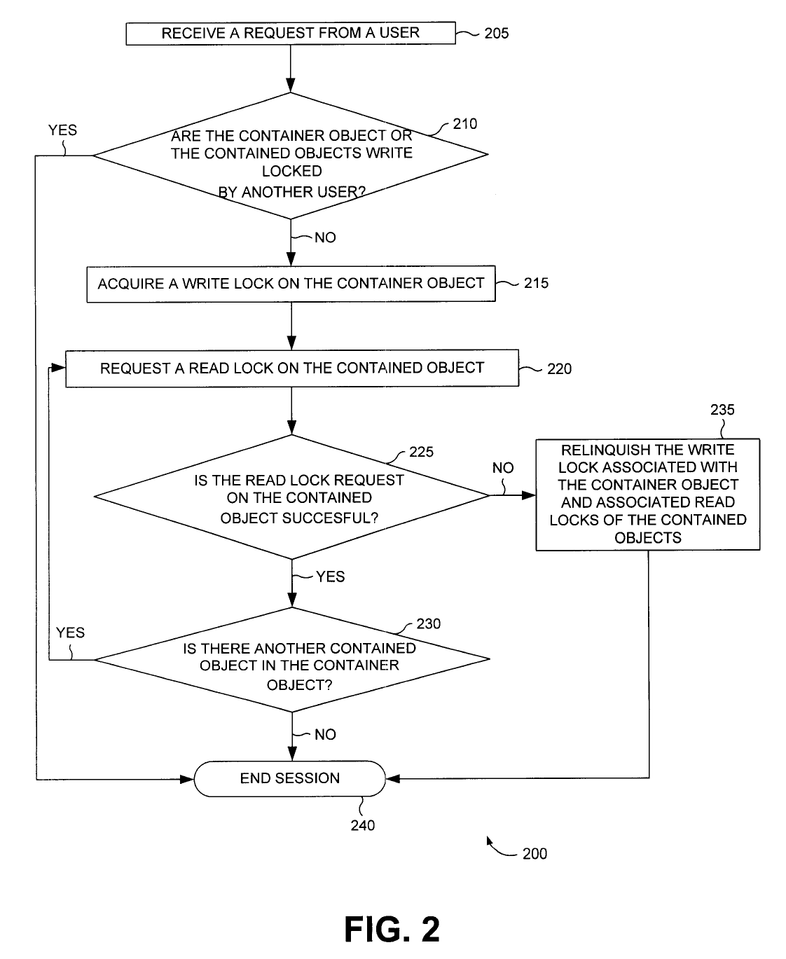

FIG. 2 is process flow 200 of providing a write lock and associated read locks for logically grouped shared objects created during run-time, according to one embodiment. In one example embodiment, FIG. 2 shows the containment hierarchy as an example of the logically grouped shared objects. Particularly, the process 200 illustrates a method of controlling access to a container object (e.g., the container object 120 of FIG. 1) and contained objects (e.g., the contained objects 110 of FIG. 1) in a multi-user environment having different user privileges. For example, the multi-user environment includes multiple containers (e.g., the containers 120 and 130 of FIG. 1), each container including logically grouped shared objects that are container locked. In one embodiment, the logically grouped shared objects are formed statically or dynamically using the container object 120 and the contained objects 110.

In operation 205, a request is received from a user (e.g., the user 1 150 of FIG. 1) to acquire an exclusive lock on the container object 120 and the contained objects 110. In operation 210, it is determined whether the container 120 and the contained objects 110 are locked by another similar privileged user (e.g., the user 2 150 shown in FIG. 1). If the container object 120 is write locked or the contained objects 110 are read locked by another similar privileged user 2 150, then the request session is ended and the user 1 150 is notified that the container object 120 and/or the contained objects 110 are locked by another user 2 150 in operation 240, else the process 200 performs operation 215. In operation 215, a write lock on the container object 120 is acquired by the user 1 150. In one embodiment, locking the container object 120 automatically applies locks to all the logically grouped shared objects or container objects 110 (as described in the following description).

In operation 220, a read lock on the contained object 110 is requested (e.g., by the user 1 150). In operation 225, a determination is made to verify whether the read lock on the contained object 110 is successful. If it is determined that the read lock request on the contained object 110 is successful, i.e., the acquiring of the read lock is successful, then another determination is made in operation 230. In operation 230, it is determined whether there is another contained object 110 in the container object 120 to be locked. If there is no another contained object 110 in the container object 120, then operation 240 is performed to end the read lock request session, else the process 200 goes to operation 220 and performs operations 220-235 for another contained object 110.

If in operation 225, it is determined that the read lock request on the contained object 110 is not successful, i.e., acquiring of the read lock is unsuccessful, then process 200 performs operation 235. In operation 235, the write lock associated with the container object 120 and associated read locks of the contained objects 110 which are acquired so far are relinquished. The process 200 then performs operation 240 to end the session by notifying the user 1 150 that the exclusive lock request is not successful as the read lock request for one of the contained objects 110 is not successful.

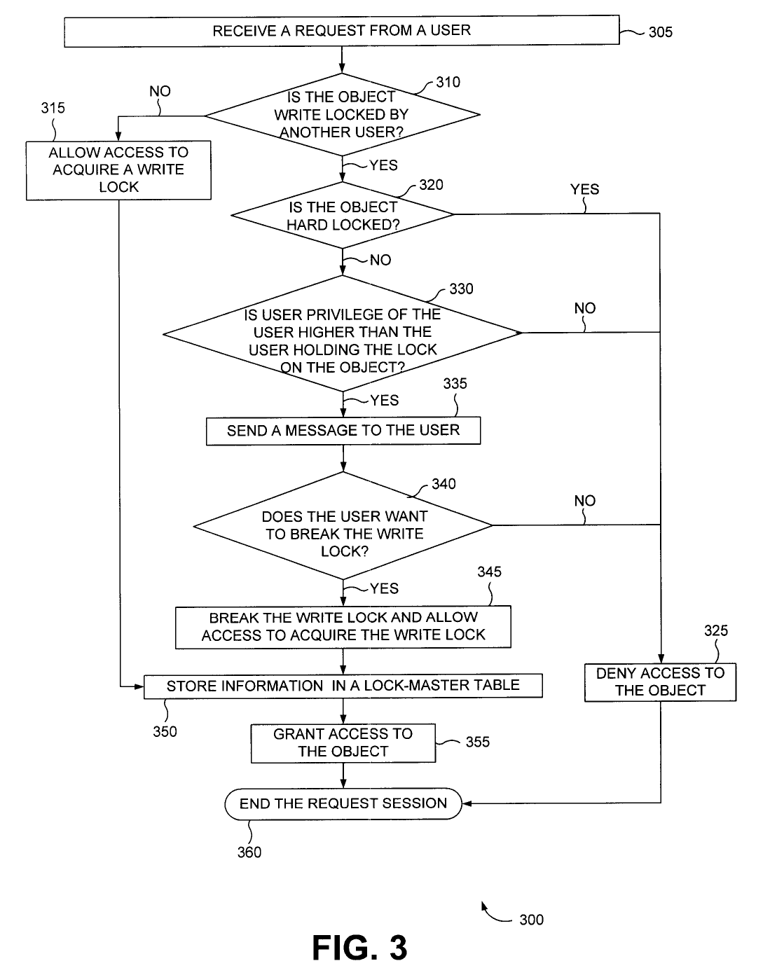

FIG. 3 is a process flow 300 of locking an object based on user privileges, according to one embodiment. In operation 305, a request is received from the user 1 150 for access to one of an object or logically grouped shared objects or an object associated with one or more logical groups. In operation 310, a determination is made to check whether the object is write locked by another user (e.g., the user 2 150).

In operation 315, if it is determined that the object is not write locked by another user, access to acquire a write lock associated with the user 1 150 is allowed. Further, the process 300 is routed to operation 350, in which information associated with each lock is stored in a lock master table (e.g., table 1) and access to the object is granted in subsequent operation (i.e., operation 355) prior to ending the request session in operation 360. For example, the lock-master table includes lock attributes including lock ID, lock type, object ID, user ID, session ID, lock count, lock time, etc.

If it is determined in operation 310 that the object is locked by another user 2 150, then in operation 320, it is determined whether the object is hard locked. It is appreciated that a hard lock is a unique lock that provides an unbreakable lock on the object, i.e., break lock cannot be called on objects that are hard locked.

If the object is hard locked, access to the object for the user 1 150 is denied by sending a non-exclusive access message to the user 1 150, in operation 325. Operation 360 is performed to end the session upon denying the access to the object. If it is determined in operation 320 that the object is not hard locked, then in operation 330, it is determined whether user privilege of the user 1 150 is higher than the user 2 150 holding the lock on the object. If the user privilege of the user 1 150 is not higher than the user 2 150 holding the lock on the object, then the process 300 performs operation 325 in which access to the object for the user 1 150 is denied, else operation 335 is performed. Upon denying the access to the object, the request session is ended and the user 1 150 is notified that the object is locked by a higher privileged user (i.e., the user 2 150) in operation 360.

If the user privilege of the user 1 150 is higher than the user 2 150 holding the lock on the object in operation 330, then the process 300 performs operation 335. In operation 335, a message is sent to the user 1 150 as to whether the user 1 150 wants to break the write lock associated with the user 2 150 holding the lock. In operation 340, it is determined whether the user 1 150 wants to break the write lock associated with the user 2 150 holding the lock. If the user 1 150 does not want to break the write lock associated with the user 2 150 holding the lock, then process 300 performs operation 325 in which access to the object is denied and the request session received from the user 1 150 for access to the object is ended in operation 360, else the process 300 goes to operation 345. In operation 345, the write lock associated with the user 2 150 holding the lock on the object is broken and access to acquire a write lock associated with the user 1 150 is allowed.

Further, in operation 350, information associated with each lock is stored in the lock-master table (e.g., table 1 discussed above). In operation 355, access to the object is granted and the process 300 ends the request session in operation 360.

One can envision that if a request from the user 1 150 is for the logically grouped shared objects or the object associated with one or more logical groups, then locking of the logically grouped shared objects or the object associated with one or more logical groups is performed in a similar manner as described above. If the request received from the user 1 150 is for the logically grouped shared objects or the object associated with one or more logical groups, then a determination is made to check whether the logically grouped shared objects or the object associated with one or more logical groups is locked by another user (e.g., the user 2 150 associated with the session 2 160 shown in FIG. 1).

In one embodiment, if it is determined that the logically grouped shared objects or the object associated with one or more logical groups is locked by another user 2 150, then the lock associated with the user 2 150, holding the lock on the logically grouped shared objects or the object associated with one or more logical groups is broken, i.e., the user privilege is higher than the one currently holding the lock, access to acquire a write lock associated with the user 1 150 is allowed and access to the logically grouped shared objects or the object associated with one or more logical groups is granted. In another embodiment, if the logically grouped shared objects or the object associated with one or more logical groups is not locked by another user 2 150, access to acquire a write lock associated with the user 1 150 is allowed and access to the logically grouped shared objects or the object associated with one or more logical groups is granted.

In some embodiments, breaking the lock associated with the user 2 150 holding the lock on the logically grouped shared objects or the object associated with one or more logical groups includes determining whether the logically grouped shared objects or the object associated with one or more logical groups is hard locked. If the logically grouped shared objects or the object associated with one or more logical groups is hard locked, access to the logically grouped shared objects or the object associated with one or more logical groups for the user 1 150 is denied by sending a non-exclusive access message to the user 1 150, else it is determined whether a user privilege of the user 1 150 is higher than the user 2 150 holding the lock on the logically grouped shared objects or the object associated with one or more logical groups.

On determining that the user privilege of the user 1 150 is higher than the user 2 150 holding the lock, a write lock associated with the user 2 150 holding the lock on the logically grouped shared objects or the object associated with one or more logical groups is broken, access to acquire the write lock associated with the user 1 150 is allowed and access to the logically grouped shared objects or the object associated with one or more logical groups is granted.

Further, in some embodiments, breaking the write lock associated with the user 2 150 includes sending a message to the user 1 150 as to whether the user 1 150 wants to break the write lock associated with the user 2 150 holding the lock. In one embodiment, if the user answers ‘yes’ and wants to break logically grouped shared objects, then the write lock associated with the user holding the lock on the logically grouped shared objects is broken. Further, a write lock is acquired on the logically grouped shared objects and a read lock is acquired on contained objects in the logically grouped shared objects. If the user answers ‘yes’ and they are not logically grouped shared objects (i.e., if it is the object associated with one or more logical groups), then the write lock associated with the user holding the lock on the logically grouped shared objects is broken. Further, a write lock is acquired on the object associated with one or more logical groups and a read lock is acquired on the objects associated with one or more logical groups. In another embodiment, if the user 1 150 answers ‘no’, access to the object is denied and the request session received from the user 1 150 for access to the logically grouped shared objects or the object associated with one or more logical groups is ended.

In one embodiment, where it is determined that the user privilege of the user 1 150 is not higher than the user 2 150 holding the lock on the logically grouped shared objects or the object associated with one or more logical groups, access to the object is denied and the request session received from the user 1 150 for the access to the logically grouped shared objects or the object associated with one or more logical groups is ended and the user 1 150 is notified that the object is locked by a higher privileged user.

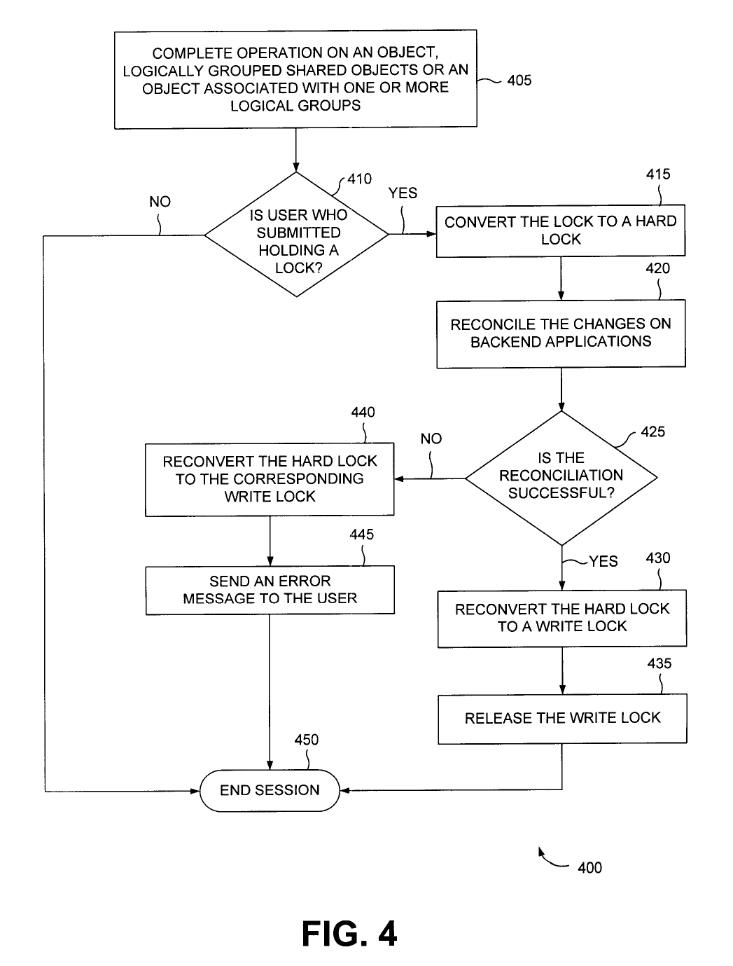

FIG. 4 is a process flow 400 of hard or unbreakable locking for an object, logically grouped shared objects or an object associated with one or more logical groups, according to one embodiment. In operation 405, operation on the object, the logically grouped shared objects or the object associated with one or more logical groups is completed.

In operation 410, it is determined whether a user 1 150 holds a lock on the object, the logically grouped shared objects or the object associated with one or more logical groups. If the user 1 150 holds the lock, then the process 400 performs operation 415, else operation 450 is performed to end the session and notify the user 1 150 that the lock on the object, the logically grouped shared objects or the object associated with one or more logical groups is lost.

In operation 415, the lock on the object, the logically grouped shared object or the object associated with one or more logical groups is converted to a hard lock on the object, the logically grouped shared objects or the object associated with one or more logical groups. In operation 420, the changes on backend applications are reconciled. In operation 425, a determination is made to check whether the reconciliation is successful or not. If the reconciliation is successful, then the process 400 performs operation 430.

In operation 430, the hard lock is reconverted to write lock on the object, the logically grouped shared objects or the object associated with one or more logical groups. In operation 435, the write lock on the object, the logically grouped shared objects or the object associated with one or more logical groups is released and the session is ended in operation 450. If the reconciliation is not successful, then the process 400 performs operation 440.

In operation 440, the hard lock is reconverted to the corresponding write lock(s) associated with the object, the logically grouped shared objects or the object associated with one or more logical groups. In operation 445, an error message is sent to the user upon performing the operation 440. Further, the hard and unbreakable locking session is ended in operation 450.

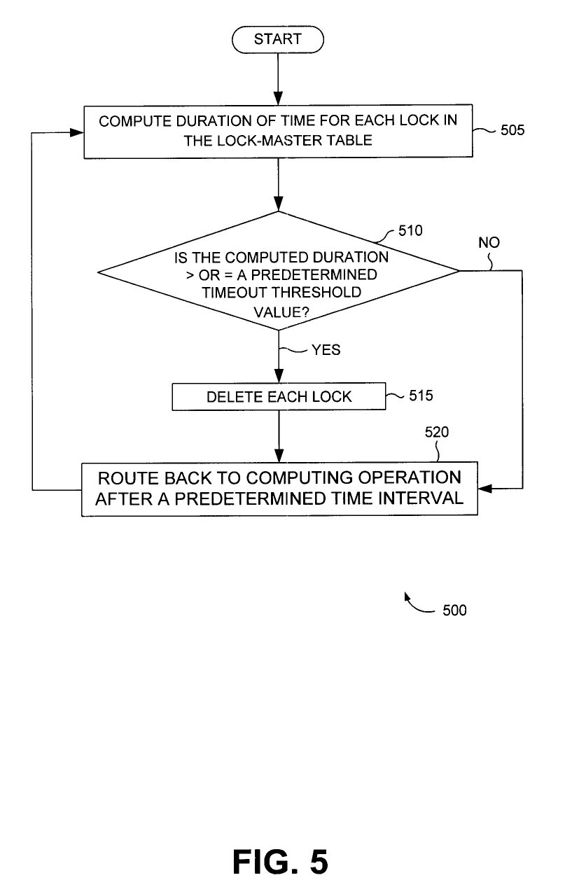

FIG. 5 is a process flow 500 of lock aging or lock timeout for an object, according to one embodiment. Particularly, the process 500 describes a method of automatic cleaning (e.g., deleting) of an object lock, logically grouped shared objects lock or an object lock associated with one or more logical groups, that is created and stored in a lock-master table (e.g., the example table 1 which includes lock attributes such as lock ID, lock type, object ID, user ID, session ID, lock count, lock time, etc.) due to application malfunctioning in a multi-user environment. It is understood to one skilled in the art that the logically grouped shared objects in the multi-user environment includes multiple containers and each container including multiple objects.

In operation 505, duration of time is computed for each lock (e.g., associated with the object, the logically grouped shared objects or the object associated with one or more logical groups) in the lock-master table (e.g., as illustrated in table 1). It is apparent that, each lock refers to a write lock associated with the object.

In operation 510, a check is made to determine whether the computed duration of time for each lock in the lock-master table is greater than or equal to a predetermined timeout threshold value. If it is determined that the computed duration of time for each lock in the lock-master table is greater than or equal to the predetermined timeout threshold value, then each lock is deleted in operation 515, else the process 500 performs operation 520. It should be noted that operation 520 is also performed upon performing operation 515. In operation 520, the process 500 is routed back to operation 505 after a predetermined time interval to repeat operations 505-515.

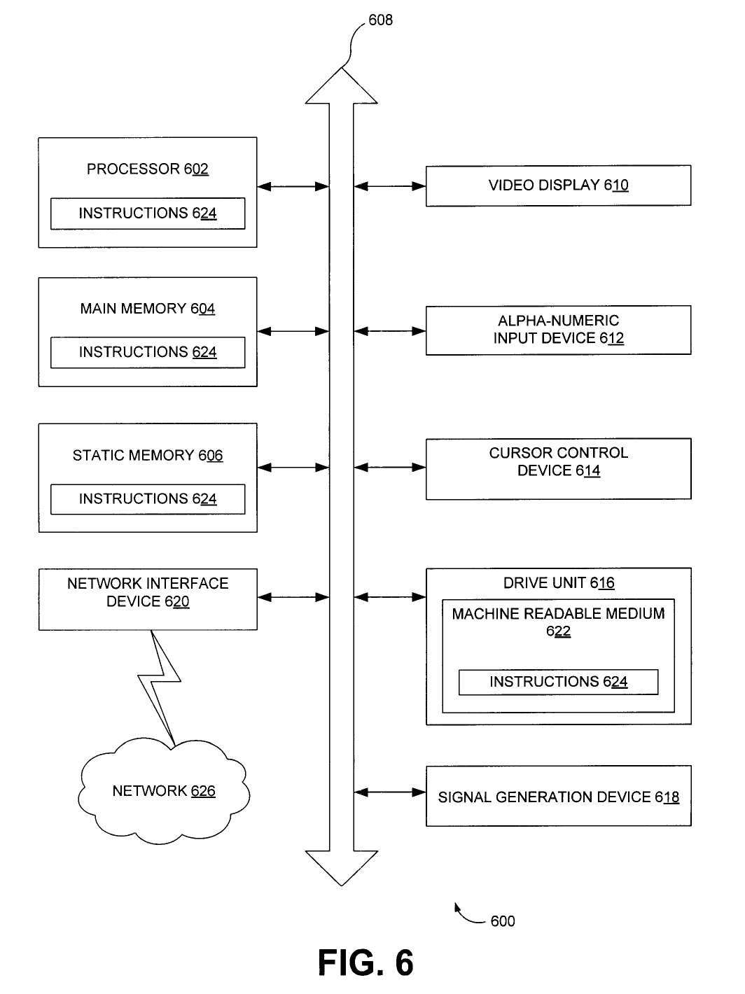

FIG. 6 is a diagrammatic system view 600 of a data processing system in which any of the embodiments disclosed herein may be performed, according to one embodiment. Particularly, the diagrammatic system view of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624 and a network 626.

The diagrammatic system view 600 may indicate a personal computer and/or a data processing system in which one or more operations disclosed herein are performed. The processor 602 may be a microprocessor, a state machine, an application specific integrated circuit, a field programmable gate array, etc. The main memory 604 may be a dynamic random access memory and/or a primary memory of a computer system. The static memory 606 may be a hard drive, a flash drive, and/or other memory information associated with the data processing system.

The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., a special device to aid the physically handicapped). The cursor control device 614 may be a pointing device such as a mouse. The drive unit 616 may be a hard drive, a storage system, and/or other longer term storage subsystem.

The signal generation device 618 may be a BIOS and/or a functional operating system of the data processing system. The network interface device 620 may perform interface functions (e.g., code conversion, protocol conversion, and/or buffering) required for communications to and from the network 626 between a number of independent devices (e.g., of varying protocols). The machine readable medium 622 may provide instructions on which any of the methods disclosed herein may be performed. The instructions 624 may provide source code and/or data code to the processor 602 to enable any one or more operations disclosed herein.

In one embodiment, an article includes a storage medium having instructions, that when executed by a computing platform, result in execution of method of controlling access to an object, logically grouped shared objects or an object associated with one or more logical groups in a multi-user environment having different user privileges, the method includes receiving a request from a user (e.g., the user 1 150 shown in FIG. 1) for access to one of the object or the logically grouped shared objects or the object associated with one or more logical groups, determining whether the request from the user 1 150 is for the object, if so, determining whether the object is locked by another user (e.g., the user 2 150 shown in FIG. 1), if so, breaking the lock associated with the user 2 150 holding the lock on the object and allowing access to acquire a write lock associated with the user 1 150 and granting access to the object, and ending the request session.

In this embodiment, breaking the lock associated with the user 2 150 holding the lock on the object further includes determining whether the object is hard locked, if not, determining whether the user privilege of the user 1 150 is higher than the user 2 150 holding the lock on the object, and if so, breaking a write lock associated with the user 2 150 holding the lock on the object, allowing access to acquire the write lock associated with the user 1 150 and granting access to the object.

In another embodiment, an article includes a storage medium having instructions, that when executed by a computing platform, result in execution of a method of controlling access to an object, logically grouped shared objects or an object associated with one or more logical groups in a multi-user environment having different user privileges, the method includes determining whether the user (e.g., the user 2 150 shown in FIG. 1) holds a lock on the object, the logically grouped shared objects or the object associated with one or more logical groups upon completion of an operation on the object, the logically grouped shared objects or the object associated with one or more logical groups and submitting changes performed on the object, the logically grouped shared objects or the object associated with one or more logical groups, if so, converting the lock the object, the logically grouped shared objects or the object associated with one or more logical groups to a hard lock on the object, the logically grouped shared objects or the object associated with one or more logical groups, reconciling the changes on backend applications, determining whether reconciliation is successful, if so, reconverting the hard lock to write lock on the object, the logically grouped shared objects or the object associated with one or more logical groups, and releasing the write lock on the object, the logically grouped shared objects or the object associated with one or more logical groups and ending the request session.

In yet another embodiment, an article includes a storage medium having instructions, that when executed by a computing platform, result in execution of method of automatically cleaning an object lock, logically grouped shared objects lock or an object lock associated with one or more logical groups that is created and stored in a lock-master table (e.g., the table 1) due to application malfunctioning in a multi-user environment, the method includes computing duration of time for each lock in the lock-master table, determining whether the computed duration of time for each lock in the lock-master table is greater than or equal to a predetermined timeout threshold value and deleting each lock based on the determination. In this embodiment, the storage medium may have instruction to repeat the steps of computing, determining and deleting at a next predetermined time interval.

In a further embodiment, an article includes a storage medium having instructions, that when executed by a computing platform, result in execution of method of controlling access to a container object (e.g., the container object 120 shown in FIG. 1) and contained objects (e.g., the contained objects 10 shown in FIG. 1) in a multi-user environment having different user privileges, the method includes receiving a request from a user (e.g., the user 1 150 shown in FIG. 1) to acquire an exclusive lock on the container object 120 and the contained objects 110, determining whether the container object 120 and contained objects 110 are locked by another user (e.g., the user 1 150 shown in FIG. 1), if not, acquiring a write lock on the container object 120, requesting a read lock on each contained object 110, and ending the exclusive locking session.

In this embodiment, requesting the read lock on each contained object 110 includes requesting a read lock on a current contained object 110, determining whether the read lock request on the current contained object 110 is successful, if so, determining if there is another contained object 110 in the container object 120, if so, requesting the read lock on a next contained object 110, and if not, ending the read lock request session.

The storage medium may have instructions to relinquish the write lock associated with the container object 120 and associated read locks of the contained objects 110, if the read lock request session is not successful, and end the session by notifying the user 1 150 that exclusive lock request is not successful as the read lock request for one of the contained objects 110 is not successful.

A computer system includes a processor and a memory coupled to the processor, the memory having stored therein code which when decoded by the processor causes the processor to perform a method of controlling access to an object, logically grouped shared objects or an object associated with one or more logical groups in a multi-user environment having different user privileges, the method includes receiving a request from a user (e.g., the user 1 150 of FIG. 1) for access to one of the object or the logically grouped shared objects or the object associated with one or more logical groups, determining whether the request from the user 1 150 is for the object, if so, determining whether the object is locked by another user (e.g., the user 2 150 of FIG. 1), if so, breaking the lock associated with the user 2 150 holding the lock on the object and allowing access to acquire a write lock associated with the user 1 150 and granting access to the object, and ending the request session.

The breaking the lock associated with the user 2 150 holding the lock on the object includes determining whether the object is hard locked, if not, determining whether the user privilege of the user 1 150 is higher than the user 2 150 holding the lock on the object, and if so, breaking a write lock associated with the user 2 150 holding the lock on the object and allowing access to acquire the write lock associated with the user 1 150 and granting access to the object.

The above-described technique provides a mechanism for user privilege based acquiring of object locks and break-lock functionality. This allows a higher privileged user to break the lock already acquired by a lower privileged user. Further, the above-described technique provides for a hard lock or unbreakable lock feature to be included on objects. This feature allows for applications or processes to acquire or convert locks to unbreakable locks for the purpose of maintaining data integrity during data transactions or during reconciliation of object data in the backend applications. Furthermore, the above-described technique provides for flexible lock aging or lock timeout feature that allows for automatic clean-up of locks that are in a lock state for an unreasonably long period of time.

The above-described technique is applicable in a multi-user environment, such as web-based applications and client server based applications where the objects are to be locked and operated from multiple users/clients. Further, the above-described technique allows users to migrate from one client to another without relinquishing locks thereby allowing the users to continue working with the objects across different clients. Also, the above-described technique provides a more flexible object lock mechanism for any logical grouping of objects. This is achieved by grouping all logically related objects under a single lock id in a lock-master table. The above-described technique provides concurrent control in a multi-user application. For example, different lock types provide flexibility to the application to different levels of concurrency. In one embodiment, the concurrency-control layer is implemented in the database for performance and abstraction.

The above-described method provides an easy-to-use locking mechanism for container or contained objects. Further, the above-described technique provides flexibility to lock all the objects in a containment hierarchy or to lock the objects independently. In addition, the above-described technique allows user to define containment hierarchy for locking.

It will be appreciated that the various embodiments discussed herein may not be the same embodiment, and may be grouped into various other embodiments not explicitly disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method of controlling access to an object, logically grouped shared objects or an object associated with one or more logical groups in a multi-user environment having different user privileges, wherein the logically grouped shared objects in the multi-user environment includes multiple containers and each container including multiple objects, comprising:
receiving a request from a user for access to one of the object or the logically grouped shared objects or the object associated with one or more logical groups;
determining whether the request from the user is for the object;
if so, determining whether the object is locked by another user;
if so, breaking the lock associated with the user holding the lock on the object and allowing access to acquire a write lock associated with the user and granting access to the object; and
ending the request session.

2. The method of claim 1, wherein breaking the lock associated with the user holding the lock on the object further comprises:
determining whether the object is hard locked;
if not, determining whether the user privilege of the user is higher than the user holding the lock on the object; and
if so, breaking a write lock associated with the user holding the lock on the object and allowing access to acquire the write lock associated with the user and granting access to the object.

3. The method of claim 2, further comprising
if the object is not locked by another user, allowing access to acquire the write lock associated with the user; and
granting access to the object.

4. The method of claim 3, further comprising:
if the object is hard locked, denying access to the object for the user by sending a non-exclusive access message to the user.

5. The method of claim 2, wherein breaking the write lock associated with the user holding the lock on the object further comprises:
sending a message to the user as to whether the user wants to break the write lock associated with the user holding the lock;
if the user answers yes, breaking the write lock associated with the user holding the lock on the object and allowing access to acquire the write lock associated with the user and granting access to the object; and
if the user answers no, denying access to the object and ending the request session received from the user for access to the object.

6. The method of claim 2, further comprising:
if the user privilege of the user is not higher than the user (is this yet another user different from the user holding the lock on the object?) holding the lock on the object, denying access to the object and ending the request session received from the user for the access to the object and notifying the user that the object is locked by a higher privileged user.

7. The method of claim 1, further comprising:
if the request from the user is for logically grouped shared objects or the object associated with one or more logical groups, determining whether the logically grouped shared objects or the object associated with one or more logical groups is locked by another user;
if so, breaking the lock associated with the user holding the lock on the logically grouped shared objects or the object associated with one or more logical groups and allowing access to acquire a write lock associated with the user and granting access to the logically grouped shared objects or the object associated with one or more logical groups; and
ending the request session.

8. The method of claim 7, wherein breaking the lock associated with the user holding the lock on the logically grouped shared objects or the object associated with one or more logical groups further comprises:
determining whether the logically grouped shared objects or the object associated with one or more logical groups is hard locked;
if not, determining whether the user privilege of the user is higher than the user holding the lock on the logically grouped shared objects or the object associated with one or more logical groups; and
if so, breaking the write lock associated with the user holding the lock on the logically grouped shared objects or the object associated with one or more logical groups and allowing access to acquire the write lock associated with the user and granting access to the logically grouped shared objects or the object associated with one or more logical groups.

9. The method of claim 7, further comprising
if the logically grouped shared objects or the object associated with one or more logical groups is not locked by another user, allowing access to acquire a write lock associated with the user; and
granting access to the logically grouped shared objects or the object associated with one or more logical groups and the container.

10. The method of claim 9, further comprising:
if the logically grouped shared objects or the object associated with one or more logical groups is hard locked, denying access to the logically grouped shared objects or the object associated with one or more logical groups for the user by sending a non-exclusive access message to the user.

11. The method of claim 7, wherein breaking the write lock associated with user holding the lock on the logically grouped shared objects or the object associated with one or more logical groups comprises:
sending a message to the user as to whether the user wants to break the write lock associated with the user holding the lock;
if the user answers yes and it is logically grouped shared objects then breaking the write lock associated with the user holding the lock on the logically grouped shared objects, acquiring a write lock on the logically grouped shared objects and acquiring read lock on contained objects in the logically grouped shared objects, and if the user answers yes and it is not logically grouped shared objects, then breaking the write lock associated with the user holding the lock on the logically grouped shared objects, acquiring a write lock on the object associated with one or more logical groups and acquiring a read lock on the objects associated with one or more logical groups; and
if the user answers no, denying access to the object and ending the request session received from the user for access to the logically grouped shared objects or the object associated with one or more logical groups.

12. The method of claim 7, further comprising:
if the user privilege of the user is not higher than the user holding the lock on the logically grouped shared objects or the object associated with one or more logical groups, denying access to the object and ending the request session received from the user for the access to the logically grouped shared objects or the object associated with one or more logical groups and notifying the user that the object is locked by a higher privileged user.

13. The method of claim 1, further comprising:
computing duration of time for each lock in the lock-master table;
determining whether the computed duration of time for each lock present in the lock-master table is greater than or equal to a predetermined timeout threshold value; and
deleting each lock based on the determination.

14. A method of controlling access to an object, logically grouped shared objects or an object associated with one or more logical groups in a multi-user environment having different user privileges, wherein the logically grouped shared objects in the multi-user environment includes multiple containers and each container including multiple objects, comprising:
determining whether the user holds a lock on the object, the logically grouped shared objects or the object associated with one or more logical groups upon completion of an operation on the object, the logically grouped shared objects or the object associated with one or more logical groups;
if so, converting the lock on the object, the logically grouped shared objects or the object associated with one or more logical groups to a hard lock on the object, the logically grouped shared objects or the object associated with one or more logical groups;
reconciling the changes on backend applications;
determining whether reconciliation is successful;
if so, reconverting the hard lock to the write lock on the object, the logically grouped shared objects or the object associated with one or more logical groups; and
releasing the write lock on the object, the logically grouped shared objects or the object associated with one or more logical groups and ending the request session.

15. The method of claim 14, further comprising:
if the user does not hold the lock on the object, the logically grouped shared objects or the object associated with one or more logical groups, ending the session and notifying the user that the lock on the object, the logically grouped shared objects or the object associated with one or more logical groups is lost.

16. The method of claim 15, further comprising:
if the reconciliation is not successful, reconverting the hard lock associated with the object, the logically grouped shared objects or the object associated with one or more logical groups to the corresponding write lock(s); and
sending an error message to the user.

17. The method of claim 14, further comprising:
computing duration of time for each lock in the lock-master table;
determining whether the computed duration of time for each lock present in the lock-master table is greater than or equal to a predetermined timeout threshold value; and
deleting each lock based on the determination.

18. A computer system comprising:
a processor; and
a memory coupled to the processor, the memory having stored therein code which when decoded by the processor, the code causes the processor to perform a method of controlling access to an object, logically grouped shared objects or an object associated with one or more logical groups in a multi-user environment having different user privileges, wherein the logically grouped shared objects in the multi-user environment includes multiple containers and each container including multiple objects, comprising:
receiving a request from a user for access to one of the object or the logically grouped shared objects or the object associated with one or more logical groups;
determining whether the request from the user is for the object;
if so, determining whether the object is locked by another user;
if so, breaking the lock associated with the user holding the lock on the object and allowing access to acquire a write lock associated with the user and granting access to the object; and
ending the request session.

19. The computer system of claim 18, wherein breaking the lock associated with the user holding the lock on the object further comprises:
determining whether the object is hard locked;
if not, determining whether the user privilege of the user is higher than the user holding the lock on the object; and
if so, breaking a write lock associated with the user holding the lock on the object and allowing access to acquire the write lock associated with the user and granting access to the object.
